(19) United States
(12) Patent Application Publication
(10) Pub. No.: US 2026/0369185 A1
(43) Pub. Date: Nov. 19, 2026

(54) LABEL FOR LASER PRINTING, METHOD FOR PRODUCING BATTERY, AND BATTERY

(71) Applicant: Panasonic Intellectual Property Management Co., Ltd., Osaka (JP)

(72) Inventors: KAZUNE NEMOTO, Osaka (JP); SATOSHI FUJIYOSHI, Osaka (JP); YOSHINORI TOKUYAMA, Osaka (JP); TOYOTAKA KATO, Osaka (JP)

(21) Appl. No.: 19/148,202

(22) PCT Filed: Oct. 26, 2023
(86) PCT No.: PCT/JP2023/038738

§ 371 Date: Jul. 15, 2025

(30) Foreign Application Priority Data
Jan. 30, 2023 (JP) 2023-012249

(51) Int. Cl. G09F 3/10; H01M 50/107; H01M 50/119

(52) U.S. Cl. CPC G09F 3/10; H01M 50/107; H01M 50/119

(57) ABSTRACT

Provided is a label for laser printing for a battery. The battery includes a power generating element and a metal case that houses the power generating element. The label for laser printing is disposed on a surface of a metal case, has a print region, and includes an adhesive layer, an Al vapor deposition layer, a resin base layer, and an ink layer. The adhesive layer, the Al vapor deposition layer, and the ink layer are arranged in this order from the metal case side. The resin base layer is disposed at an arbitrary position on an opposite side of the adhesive layer to the metal case. The lightness L* of at least the printing region of the label for laser printing is 45 or more.

### BACKGROUND

### 1. Technical Field

The present disclosure relates to a label for laser printing, a method for manufacturing a battery, and a battery.

### BACKGROUND ART

### 2. Description of the Related Art

The battery includes a power generating element and a metal case that houses the power generating element. An outer label is attached to a surface of the metal case of the battery. Information on the product such as a recommended expiration date is set forth on the outer label.

Patent Literature 1 proposes “a method for printing on a battery outer casing body of a battery using a label material having shrinkability and tackiness as the battery outer casing body, the method comprising printing a symbol on a print portion of the label material by using a laser in a state where a surface temperature of the label material is lower than an outside air temperature”.

Patent Literature 2 proposes “a package comprising a laminate having at least one laser printing layer on which print can be performed by using laser irradiation, the laser printing layer having a laser print portion printed by using laser and a non-print portion, the laminate further having a seal layer, wherein the package has the seal layer as at least the innermost layer, at least portions of the seal layer of the innermost layer are bonded to each other, and the package satisfies the following requirements (1) to (3)”. The requirement (1) is that the difference in color L* value between the laser print portion and the non-print portion is 1.0 or more and 10 or less. The requirement (2) is that the adhesive strength between the sealing layers is 2 N/15 mm or more and 80 N/15 mm or less. The requirement (3) is that a lamination strength between the laser printing layer and a layer adjacent to at least one surface of the laser printing layer is 2 N/15 mm or more and 10 N/15 mm or less.

### CITATION LIST

### Patent Literature

Patent Literature 1: Unexamined Japanese patent publication No. H04-349341
Patent Literature 2: WO 2022/153965

### SUMMARY

In the label for laser printing including an Al vapor deposition layer, a portion of the Al vapor deposition layer is selectively oxidized, dissolved, or evaporated by laser irradiation and removed to form a print portion. When such a label is attached to the surface of the metal case of the battery, the print portion picks up color and gloss of the metal case which is a base of the label, and the print portion can be visually recognized due to contrast with the non-print portion.

However, a large stress is applied to the metal case in the manufacturing process of the battery, and the metal case is likely to swell or dent. Therefore, a relatively large number of unevennesses are present on the surface of the metal case of the battery. When the label is attached to the surface of the metal case of such a battery, air bubbles are included between the metal case and the label, the contrast between the print portion and the non-print portion is weakened due to the presence of the air bubbles, and the visibility of the print portion is decreased.

One aspect of the present disclosure relates to a label for laser printing for a battery, the battery including a power generating element and a metal case housing the power generating element, the label for laser printing being disposed on a surface of the metal case and having a print region, the label for laser printing including an adhesive layer, an Al vapor deposition layer, a resin base layer, and an ink layer, the adhesive layer, the Al vapor deposition layer, and the ink layer being disposed in this order from a side of the metal case, the resin base layer being disposed at an arbitrary position on an opposite side of the adhesive layer to the metal case, and a lightness L* of at least the print region being 45 or more.

Another aspect of the present disclosure relates to a method for manufacturing a battery, the method including: a first step of obtaining the label for laser printing; a second step of obtaining a battery including a metal case and a power generation element housed in the metal case; a third step of performing printing in the printing region by laser irradiation; and a fourth step of disposing the label for laser printing on a surface of the metal case, wherein in the third step, the printing in the printing region is performed by removing a portion of the Al vapor deposition layer by the laser irradiation.

Still another aspect of the present disclosure relates to a battery including: a power generating element; a metal case housing the power generating element; and a label for laser printing disposed on a surface of the metal case, wherein the label for laser printing includes an adhesive layer, an Al vapor deposition layer, a resin base layer, and an ink layer, and the adhesive layer, the Al vapor deposition layer, and the ink layer are disposed in this order from a side of the metal case, the resin base layer is disposed at an arbitrary position on an opposite side of the adhesive layer to the metal case, the label for laser printing has a print region in which a portion of the Al vapor deposition layer is removed by laser irradiation, and a lightness L* of a non-print portion of the printing region is 45 or more.

In the present disclosure, it is possible to suppress a decrease in visibility of the print portion of the print region of the label for laser printing provided on the surface of the metal case of the battery.

### BRIEF DESCRIPTION OF DRAWINGS

FIG. 1 is a perspective view schematically illustrating an example of a battery according to an embodiment of the present disclosure.

FIG. 2 is a cross-sectional view of a main portion schematically showing an example of a vicinity of a label for laser printing provided on a surface of a metal case of a battery.

FIG. 3 is a schematic front view showing a cross section of a horizontal half of an alkaline dry battery as another example of the battery according to the embodiment of the present disclosure.

FIG. 4 is a diagram showing evaluation results of the label for laser printing according to the embodiment of the present disclosure.

FIG. 5 is a diagram showing evaluation results of the label for laser printing according to the embodiment of the present disclosure.

FIG. 6 is a diagram showing evaluation results of the label for laser printing according to the embodiment of the present disclosure.

### DESCRIPTION OF EMBODIMENT

Hereinafter, an embodiment of the present disclosure will be described with examples, however, the present disclosure is not limited to the examples described below. In the following description, specific numerical values and materials may be exemplified, but other numerical values and materials may be applied as long as the effects of the present disclosure are obtained. In the present specification, the expression “numerical value A to numerical value B” includes the numerical value A and the numerical value B, and can be read as “numerical value A or more and numerical value B or less”. In the following description, when a lower limit and an upper limit are exemplified with respect to numerical values of specific physical properties and conditions, any of the exemplified lower limits and any of the exemplified upper limits can be arbitrarily combined as long as the lower limit is not equal to or greater than the upper limit. When a plurality of materials are exemplified, one of the materials may be selected and used alone, or two or more thereof may be used in combination.

Furthermore, the present disclosure encompasses a combination of matters described in two or more claims arbitrarily selected from a plurality of claims described in the appended claims. That is, as long as there is no technical contradiction, matters described in two or more claims arbitrarily selected from a plurality of claims described in the appended claims can be combined.

### Label for Laser Printing

A label for laser printing according to an embodiment of the present disclosure is used for a battery including a power generating element and a metal case that houses the power generating element. The label for laser printing is disposed on a surface of the metal case.

The label for laser printing has a print region. The print region has, for example, a size of 3-6 mm×10-20 mm. The entire of the label for laser printing may be the print region. The label for laser printing may have a print region in the portion thereof, or may have a non-print region other than the print region. The brightness L* of the non-print region may be the same as or different from that of the printing region.

The label for laser printing includes an adhesive layer, an Al vapor deposition layer, a resin base layer, and an ink layer. The adhesive layer, the Al vapor deposition layer, and the ink layer are disposed in this order as viewed from the metal case. The resin base layer is disposed at an arbitrary position on an opposite side of the adhesive layer to the metal case. That is, the resin base layer may be disposed between the adhesive layer and the Al vapor deposition layer, may be disposed between the Al vapor deposition layer and the ink layer, or may be disposed on the opposite side of the ink layer to the Al vapor deposition layer. A plurality of the resin base layers may be disposed at two or more of these three locations.

By the laser irradiation, a portion of the Al vapor deposition layer is selectively oxidized, dissolved, or evaporated and removed to form a print portion. The print portion picks up the color and gloss of the metal case which is the base of the label, and the print portion can be visually recognized by contrast with the non-print portion.

The lightness L* of at least the print region of the label for laser printing is 45 or more. In this case, a decrease in the visibility of the print portion when air bubbles are included between the metal case of the battery and the label (in the adhesive layer) is suppressed.

The lightness L* of at least the print region of the label for laser printing is preferably 50 or more, and may be 50 or more and 70 or less.

The lightness L* can be adjusted based on, for example, the color of the ink (pigment) used for forming the ink layer, the ratio of the application area per unit area of the ink (pigment) (the dot frequency of the pigment (color) per unit area), and the number of times of application of the ink (pigment).

The lightness L* is determined in accordance with JIS Z 8781-4: 2013 “Colorimetry—Section 4: CIE 1976 L*a*b* color space” in Japanese Industrial Standards. Using a spectral chromometer (NR-11, manufactured by Nippon Denshoku Industries Co., Ltd.), the lightness L* of a print region is measured by a reflection method in a state where a label (3 mm square or more) is attached to a mount.

The ink layer can be formed using an ink containing a pigment of a predetermined color. The thickness of the ink layer is, for example, 0.1 to 4 μm. The ink layer preferably contains a white pigment. The ink layer is preferably formed using a white ink containing a white pigment. Examples of the white pigment include zinc oxide, titanium dioxide, barium sulfate, barite powder, and white lead.

The ink layer may be configured by laminating a first ink layer and a second ink layer closer to the Al vapor deposition layer than the first ink layer. One of the first ink layer and the second ink layer may be formed using a white ink, and the other of the first ink layer and the second ink layer may be formed using a red, yellow, or blue ink.

Examples of the resin base layer include a polyester resin, a polyolefin resin, a polyamide resin, a polystyrene resin, and a polyvinyl chloride resin. Examples of the polyester resin include polyethylene terephthalate (PET) and polybutylene terephthalate. Examples of the polyolefin resin include polypropylene and polyethylene. Examples of the polyamide resin include nylon 6 and nylon 66. As the resin base layer, a resin film formed by a known method using a predetermined resin material can be used. The resin film may be produced by a uniaxial stretching method or a biaxial stretching method, and may be a non-stretched film. Layers such as an Al vapor deposition layer, an ink layer, and an adhesive layer may be formed on the resin film. The thickness of the resin base layer is, for example, 20 to 100 μm.

The thickness of the Al vapor deposition layer is, for example, 0.01 to 0.2 um. The Al vapor deposition layer is an aluminum metal layer formed by a vapor deposition method.

Examples of the adhesive layer include acrylic polymers. Air bubbles may be contained in the adhesive layer when the label is attached to the metal case of the battery. A mount may be disposed on the adhesive layer. An adhesive layer may be present between any two layers adjacent to each other in the laminate (an Al vapor deposition layer, an ink layer, and a resin base layer) constituting the label. The glue layer may be formed of the same material as the adhesive layer.

Examples of the label include a laminate of (the adhesive layer/the Al vapor deposition layer/the resin base layer/the ink layer/the glue layer/the resin base layer), a laminate of (the adhesive layer/the resin base layer/the Al vapor deposition layer/the glue layer/the ink layer/the resin base layer), and a laminate of (the adhesive layer/the Al vapor deposition layer/the resin base layer/the ink layer/the UV curable resin layer). The UV curable resin layer is a layer containing a cured product of a resin composition containing an ultraviolet (UV) curable resin and a curing aid.

The label for laser printing of the present disclosure may be brought into close contact with the surface of the metal case by bringing the adhesive layer into close contact with the surface of the metal case and then heat-shrinking the adhesive layer by heat treatment. In the label, the resin base layer may have thermal shrinkability, or a thermal-shrinkable resin film may be disposed separately from the resin base layer.

### Method for Manufacturing Battery

A method for manufacturing a battery according to the embodiment of the present disclosure includes the following first to fourth steps.

Step 1: The label for laser printing is obtained.

Second step: A battery including a metal case and a power generating element housed in the metal case is obtained.

Third step: Printing is performed in the print region by laser irradiation. Printing in the print region is performed by removing a portion of the Al vapor deposition layer by laser irradiation.

Fourth step: a label for laser printing is disposed on the surface of the metal case.

By the laser irradiation in the third step, a portion of the Al vapor deposition layer in the print region is removed to form a print portion. In the print region, for example, a manufacturing date, a lot number, and a recommended expiration date are printed. In the laser irradiation, for example, a YVO₄ laser can be used.

The fourth step may be performed after the third step, or the third step may be performed after the fourth step. That is, the printing in the print region may be performed after the label for laser printing is attached to the surface of the metal case of the battery. Alternatively, printing in the print region may be performed on the label for laser printing on the mount, and then the label where the printing has been performed in the print region may be peeled off from the mount and attached to the surface of the metal case.

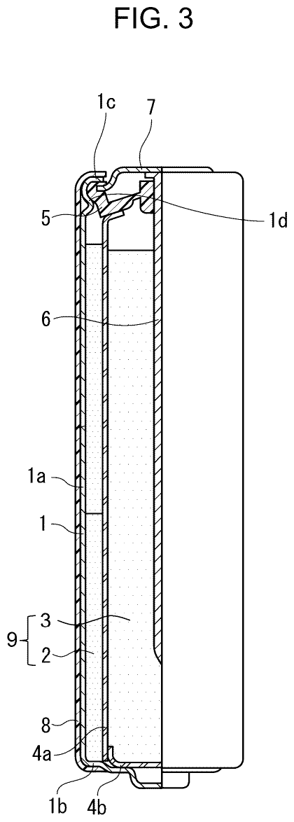

Examples of the shape of the battery produced in the second step include a cylindrical shape or a hollow prism shape. Examples of the battery produced in the second step include alkaline dry batteries (such as an alkaline dry battery having a structure shown in FIG. 3), manganese dry batteries, lithium secondary batteries, lithium primary batteries, nickel-metal hydride storage batteries, and nickel-cadmium storage batteries. The power generating element includes, for example, a positive electrode, a negative electrode, and an electrolyte. A separator may be present between the positive electrode and the negative electrode.

The metal case has, for example, a cylindrical or hollow prism-shaped side portion, a first end portion on one side of the side portion, and a second end portion on the other side of the side portion. At least one of the first end portion and the second end portion has a terminal portion connected to an external device. The label is preferably attached to the surface of the cylindrical or hollow prism-shaped side portion, and may be attached to the surfaces of the first end portion and the second end portion (excluding the terminal portion).

The metal case may include a metal can having a bottomed cylindrical or hollow prism shape. In this case, in the fourth step, the label for laser printing is disposed on the surface of the metal can (excluding the terminal portion when the metal can has the terminal portion). The metal case may further include a metal sealing plate that covers the opening of the metal can. For example, the end of the opening of the metal can may be swaged on the metal sealing plate via a gasket to form a swaged portion. The side and bottom of the metal can may form the side and first end of the metal case, respectively. The swaged portion of the metal can may form a peripheral edge of the second end of the metal case. The label is preferably attached to the side portion of the metal can, and may be attached to the bottom portion (excluding the terminal portion) and the swaged portion of the metal can. The metal can may have a bottomed cylindrical shape or a bottomed hollow prism shape.

In the manufacturing process of the battery, a large stress is applied to the side portion of the metal can, and the side portion is likely to swell or dent. In the step of sealing the metal can or the step of inserting (press-fitting) the power generating element into the metal can, the stress is likely to be applied to the side portion of the metal can, the swelling or the dent is likely to occur at the side portion (particularly, the side close to the opening), and air bubbles are likely to be included between the side portion and the label when the label is attached. The step of sealing the metal can includes, for example, a step of forming an annular groove (groove portion 1d in FIG. 3) in the vicinity of the end of the opening of the metal can, and a step of swaging the end of the opening of the metal can to the peripheral edge of the metal sealing plate via a gasket to form a swaged portion (swaged portion 1c in FIG. 3).

Examples of the material of the metal case include a nickel-plated steel plate, a stainless steel (SUS) plate, a zinc plate, and a tin plate. The metal case (metal can) is produced by press-forming these materials into a predetermined shape. The press forming is performed by a method such as a drawing process or a DI (draw and ironing) processing.

### Battery

A battery according to the embodiment of the present disclosure is obtained by the above manufacturing method. That is, the battery includes the power generating element, the metal case housing the power generating element, and the label for laser printing disposed on a surface of the metal case. The label for laser printing includes the adhesive layer, the Al vapor deposition layer, the ink layer, and the resin base layer. The adhesive layer adheres to the metal case. The Al vapor deposition layer, the ink layer, and the resin base layer are disposed on an opposite side of the adhesive layer to the metal case. The ink layer is disposed on an opposite side of the Al vapor deposition layer to the adhesive layer. The label for laser printing has a print region including a print portion in which a portion of the Al vapor deposition layer has been removed by laser irradiation. The lightness L* of the non-print portion other than the print portion in the print region is 45 or more.

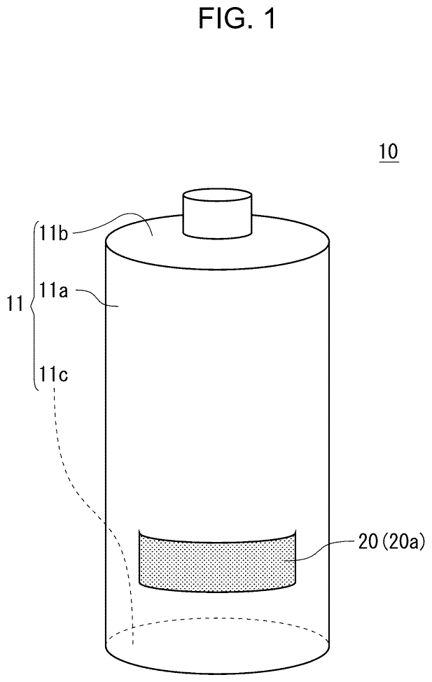

FIG. 1 is a perspective view schematically illustrating an example of the battery according to the embodiment of the present disclosure.

The battery 10 which has a cylindrical shape and includes a metal case 11 that houses a power generation element. The metal case 11 has a side portion 11a which is cylindrical, a first end portion 11b at the end of the side portion 11a, and a second end portion 11c at the other end of the side portion 11a. The first end portion 11b includes a positive electrode terminal portion (e.g., a central protrusion portion), and the second end portion 11c includes a negative electrode terminal portion. The label for laser printing 20 is disposed on the surface of the side portion 11a. The entire of the of the label for laser printing 20 has a print region 20a. In FIG. 1, the label 20 is attached to a portion of the side portion 11a, but the position to which the label 20 is attached is not limited thereto. For example, the label 20 may be attached to the entire of the side portion 11a, or the label 20 may be attached to the surfaces of the first end portion 11b and the second end portion 11c (excluding the terminal portion). The print region 20a may be provided on a portion of the label 20. For example, the label 20 may be disposed on the entire of the side portion 11a, and the shaded portion in FIG. 1 may be the print region 20a.

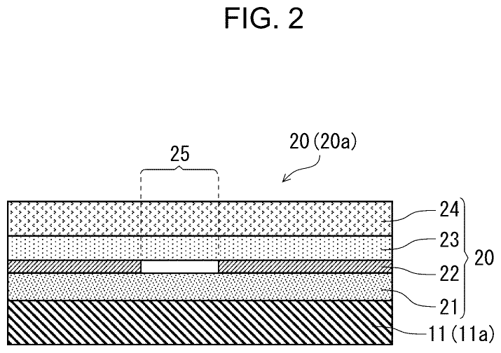

Here, FIG. 2 is a cross-sectional view of a main portion schematically showing an example of the vicinity of the label for laser printing 20 (more specifically, print region 20a) disposed on the surface of the side portion 11a of the metal case 11 of the battery 10.

The label for laser printing 20 is composed of an adhesive layer 21, an Al vapor deposition layer 22, a resin base layer 23, and an ink layer 24 in this order from the side portion 11a. The label 20 has a print region 20a including a print portion 25 in which a portion of the Al vapor deposition layer 22 has been removed by laser irradiation. The lightness L* of the non-print portion other than the print portion 25 of the printed region 20 a is 45 or more. The resin base layer 23 in FIG. 2 is disposed between the Al vapor deposition layer 22 and the ink layer 24, but the position and the number of the resin base layer are not limited thereto. The resin base layer may be disposed between the adhesive layer 21 and the Al vapor deposition layer 22 or on the side of the ink layer 24 opposite to the Al vapor deposition layer. The adhesive layer 21, the Al vapor deposition layer 22, the resin base layer 23, and the ink layer 24 are laminated on one another.

Here, FIG. 3 is a front view showing a cross section of a lateral half of an alkaline dry battery as another example of the battery.

The alkaline dry battery includes a hollow cylindrical positive electrode 2, a negative electrode 3 disposed in a hollow portion of the positive electrode 2, a separator disposed therebetween, and an electrolytic solution, and these are housed in a bottomed cylindrical metal can 1 having a side portion 1a and a bottom portion 1b. The bottom portion 1b of the metal can 1 doubles as a positive electrode terminal. The hollow cylindrical positive electrode 2 is in close contact with the inner surface of the side portion 1a of the metal can 1. The positive electrode 2 is formed by press-fitting a plurality of hollow cylindrical positive electrode mixture pellets containing manganese dioxide, graphite, and an electrolytic solution into the metal can 1. The hollow portion of the positive electrode 2 is filled with the negative electrode 3 which is gelled in such a manner that a separator is provided between the positive electrode 2 and the negative electrode 3. The positive electrode 2, the negative electrode 3, the separator, and the electrolytic solution constitute a power generating element 9 housed in the metal can 1.

The negative electrode 3 usually contains an electrolytic solution and a gelling agent in addition to the negative electrode active material containing zinc. The separator has a bottomed cylindrical shape and includes a cylindrical separator 4a and a bottom paper 4b. The separator 4a is disposed along the inner surface of the hollow portion of the positive electrode 2, and separates the positive electrode 2 and the negative electrode 3 from each other. The bottom paper 4b is disposed at the bottom of the hollow portion of the positive electrode 2, and separates the negative electrode 3 from the metal can 1.

The opening of the metal can 1 is sealed by a sealing unit. The sealing unit includes a gasket 5, a negative electrode terminal plate 7 (metal sealing plate) which doubles as a negative electrode terminal, and a negative electrode current collector 6.

A negative electrode current collector 6 is inserted into the negative electrode 3. The material of the negative electrode current collector 6 is, for example, an alloy containing copper and zinc, such as brass. The negative electrode current collector 6 has a nail shape having a head portion and a body portion. The body portion is inserted into a through hole provided in a central cylindrical portion of the gasket 5, and the head portion of the negative electrode current collector 6 is welded to a central portion of the negative electrode terminal plate 7.

An annular groove portion 1d is provided in a region of the side portion 1a of the metal can 1 closer to the opening than to the positive electrode 2, and the end portion of the opening (a region of the side portion 1a closer to the opening than to the groove portion 1d) of the metal can 1 is swaged to a peripheral edge portion of the negative electrode terminal plate 7 via an outer peripheral end portion of the gasket 5 to form a swaged portion 1c.

The outer label 8 is disposed on the surfaces of the side portion 1a, the bottom portion 1b (the peripheral portion excluding the central protrusion portion), and the swaged portion 1c of the metal can 1. At least a portion of the outer label 8 is a label for laser printing. The outer label 8 is not limited thereto. The entire of the outer label 8 may be a label for laser printing, or the outer label 8 may be attached to a portion of the surface of the side portion 1a of the metal can 1.

### Supplementary Notes

The following techniques are disclosed by the above description of the embodiment.

### Technique 1

A label for laser printing for a battery, wherein
the battery comprises a power generating element and a metal case for housing the power generating element,
the label for laser printing includes a print region which is disposed on a surface of the metal case and configured to be printed by laser irradiation, and
the label for laser printing comprises an adhesive layer, an Al vapor deposition layer, a resin base layer, and an ink layer,
the adhesive layer, the Al vapor deposition layer, and the ink layer are disposed in this order from a side of the metal case,
the resin base layer is disposed at an arbitrary position on an opposite side of the adhesive layer to the metal case, and
a lightness L* of at least the print region is 45 or more.

### Technique 2

The label for laser printing according to Technique 1, wherein the lightness L* is 50 or more and 70 or less.

### Technique 3

The label for laser printing according to Technique 1 or 2, wherein the ink layer contains a white pigment.

### Technique 4

The label for laser printing according to any one of Techniques 1 to 3, wherein
the resin base layer contains a polyester resin.

### Technique 5

The laser marking label according to Technique 4, wherein
the polyester resin contains polyethylene terephthalate.

### Technique 6

A method for manufacturing a battery, the method comprising:
a first step of obtaining the label for laser printing for the battery according to Technique 1;
a second step of obtaining the battery comprising a metal case and a power generating element housed in the metal case;
a third step of printing on the print region by laser irradiation;
a fourth step of disposing the label for laser printing on a surface of the metal case;
wherein
in the third step, the printing is performed in the print region by removing a portion of the Al vapor deposition layer by the laser irradiation.

### Technique 7

The method of manufacturing the battery according to Technique 6, wherein
the metal case includes a metal can which has a bottomed cylindrical shape, and
in the fourth step, the label for laser printing is disposed on the surface of the metal can.

### Technique 8

The method of manufacturing a battery according to Technique 6 or 7, wherein
a material of the metal case is a nickel-plated steel plate.

### Technique 9

A battery, comprising:
a power generating element;
a metal case for housing the power generating element; and
a label for laser printing disposed on a surface of the metal case,
wherein
the label for laser printing comprises:
   an adhesive layer;
   an Al vapor deposition layer;
   a resin base layer; and
   an ink layer,
the adhesive layer, the Al vapor deposition layer, and the ink layer are disposed in this order from a side of the metal case, and
the resin base layer is disposed at an arbitrary position on an opposite side of the adhesive layer to the metal case,
the label for laser printing includes a print region including a print portion in which a portion of the Al vapor deposition layer has been removed by laser irradiation, and
a lightness L* of a non-print portion other than the print portion in the print region is 45 or more.

### Technique 10

The battery according to Technique 9, wherein
the metal case includes a metal can which has a bottomed cylindrical shape or a bottomed hollow prism shape, and
the label for laser printing is disposed on a surface of the metal can.

### Technique 11

The battery according to Technique 9 or 10, wherein
a material of the metal case is a nickel-plated steel plate.

### EXAMPLES

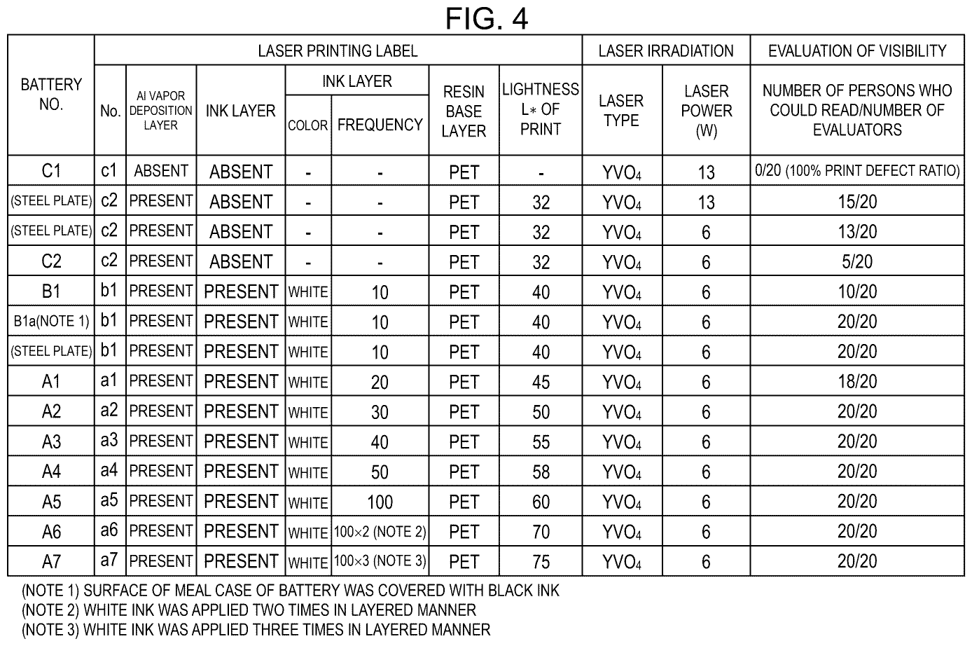

Hereinafter, the present disclosure will be described in more detail based on Examples. FIGS. 4 to 6 are diagrams illustrating evaluation results of the label for laser printing according to the embodiment of the present disclosure. It should be noted that the present disclosure is not limited to the examples.

### Batteries A1 to A7 and B1

A battery to which a label was attached was produced by the following procedure.

### Preparation of Labels a1 to a7 and b1: First Step

A label for laser printing composed of (adhesive layer/Al vapor deposition layer/resin base layer/ink layer) was produced. The resin base layer was a PET layer.

A portion of the label was used as a print region. The size of the print region was 5 mm×13 mm.

A white ink was used to form the ink layer. Titanium dioxide was used as the white pigment contained in the white ink.

The frequency of white color of the ink layer was set to a value shown in FIG. 4. The frequency was calculated from the ratio of the application area per unit area of the ink (pigment) in the printing region. The frequency of white was expressed as a relative value when the frequency in the case of the label a5 was set to 100. The color frequency is an index indicating the amount of the used pigment, and was changed depending on the application area or the number of applications of the ink (pigment).

In the labels b1 and a1 to a5, the number of times of application of the ink was one, and the application area of the ink (pigment) was changed. In the labels a6 and a7, the same ink as in the case of the label a5 was used, and the number of times of application of the ink was changed.

The brightness of the label (print region) was measured by the method described above. The measured brightness was the value shown in FIG. 4. After printing, the brightness of the non-print portion of the print region of the label is shown.

### Assembly of Battery: Second Step

An AA alkaline dry battery having the same structure as in FIG. 3 was produced.

A metal can 1 which had a bottomed cylindrical shape and was produced by a DI processing of a nickel-plated steel sheet was prepared. A plurality of hollow cylindrical positive electrode mixture pellets containing manganese dioxide, graphite, and an electrolytic solution were press-fitted into the metal can 1 to form the hollow cylindrical positive electrode 2 in close contact with the inner surface of the metal can 1. The negative electrode 3 was filled in the hollow portion of the positive electrode 2 via the separator 4a and the bottom paper 4b. The separator 4a and the bottom paper 4b were impregnated with an electrolytic solution. As the negative electrode 3, a gelled negative electrode containing a negative electrode active material containing zinc, a gelling agent, and an electrolytic solution was used.

The head of the negative electrode current collector 6 was electrically welded to the negative electrode terminal plate 7. Thereafter, the body portion of the negative electrode current collector 6 was press-fitted into the through hole of the resin gasket 5. In this manner, a sealing unit including the gasket 5, the negative electrode terminal plate 7, and the negative electrode current collector 6 was produced.

An annular groove portion 1d was provided close to the opening of the side portion 1a of the metal can 1. The sealing unit was installed at the opening of the metal can 1. At this time, the body portion of the negative electrode current collector 6 was inserted into the negative electrode 3. An opening end portion of the metal can 1 (a region of the side portion 1a closer to the opening than to the groove portion 1d) was swaged to a peripheral edge portion of the negative electrode terminal plate 7 via the gasket 5 to form the swaged portion 1c, thereby sealing the opening portion of the metal can 1. Thus, an alkaline dry battery was produced.

### Print on Label by Laser Irradiation: Third Step

By laser irradiation, characters “01-2033” indicating the recommended expiration date (month-year) were printed on the print region of the label. The size of the characters was constant. The printing was performed on the label on an amount. That is, the printing was performed before the label was attached to the battery. In the laser irradiation, a YVO₄ laser was used, and the laser output was set to 6 W.

### Attachment of Label to Battery: Fourth Step

The printed label was peeled off from the mount, and the label was attached to the surface of the side portion 1a of the metal can 1 of the alkaline dry battery. In this manner, batteries A1 to A7 and B1 to which the labels a1 to a7 and b1 were attached were obtained.

### Battery C1

A label c1 was obtained in the same manner as the label a1, except that the Al vapor deposition layer and the ink layer were not provided. In the laser irradiation, a YVO₄ laser was used, and the laser output was set to 13 W.

A battery C1 to which the label c1 was attached was obtained in the same manner as the battery A1, except that the label c1 was used instead of the label a1.

### Battery C2

A label c2 was obtained in the same manner as the label a1, except that the ink layer was not provided. In the laser irradiation, a YVO₄ laser was used, and the laser output was set to 6 W or 13 W.

A battery C2 to which the label c2 was attached was obtained in the same manner as the battery A1, except that the label c2 was used instead of the label a1.

### Evaluation 1: Evaluation of Visibility of Print on Label Attached to Battery

Under an illuminance of 1,500 lux, the battery to which the label was attached was separated from the eye position by 40 cm, and the visibility of the print portion was determined. Specifically, the readability of each battery was determined by 20 persons (10 to 76 years old), and the number of persons who could read the printed characters (the number of readable persons) among the 20 persons was counted.

The results of Evaluation 1 are shown in FIG. 4. In FIG. 4, the labels a1 to a7 and the batteries A1 to A7 are practical examples, and the labels b1 and c1to c2 and the batteries B1 and C1 to C2 are comparative examples.

In the batteries A1 to A7 to which the labels a1 to a7 having a lightness L* of 45 or more were attached, bubbles were present between the print region and the metal can (side portion) of the battery, but good visibility was obtained. In particular, in the case of the labels a2 to a7 having a lightness L* of 50 or more, no battery was determined to have poor visibility. In the labels a1 to a7, the label deformation ratio and the print defect ratio obtained on the basis of on the basis of Evaluation 2, which will be described later, were all 0%.

In the battery B1 to which the label b1 was attached, the lightness L* was as low as 40, and air bubbles were present between the resin base layer in the printed region and the metal can (side portion) of the battery, so that the visibility was decreased.

Further, in order to examine influence of the color and gloss of the object to which the label is attached on the visibility by using the label b1, a battery B1a having the same configuration as that of the battery B1 except that the surface of the side portion of the metal can was coated with black ink was produced. The label b1 was attached to the battery B1a, and Evaluation 1 was performed. As a result, the visibility was improved by coating the side surface with the black ink. As described above, it was confirmed that the visibility of the label changed depending on the color and gloss of the surface of the object to which the label is attached.

In the label c1 in which the Al vapor deposition layer and the ink layer were not provided, since the print portion was not formed, the print defect ratio obtained on the basis of Evaluation 2, which will be described later, was 100%, and the print portion was not visible in all of the batteries C1.

In the label c2 in which the ink layer was not provided, the lightness L* was as low as 32, and air bubbles were present between the printed region and the metal can (side portion) of the battery, so that the visibility of the print portion of the label c2 attached to the battery C2 was decreased.

Further, the labels b1 and c2 were attached to a nickel-plated steel plate and subjected to the same visibility evaluation as in Evaluation 2. When the label was attached to the nickel-plated steel plate, no air bubbles were included between the label and the steel plate at the time of attaching the label. Therefore, even when the labels b1 and c2 having low lightness L* were used, the visibility was better than that in the case of attaching the label to the metal can of the battery.

### Evaluation 2: Evaluation of Reliability to Laser Printing

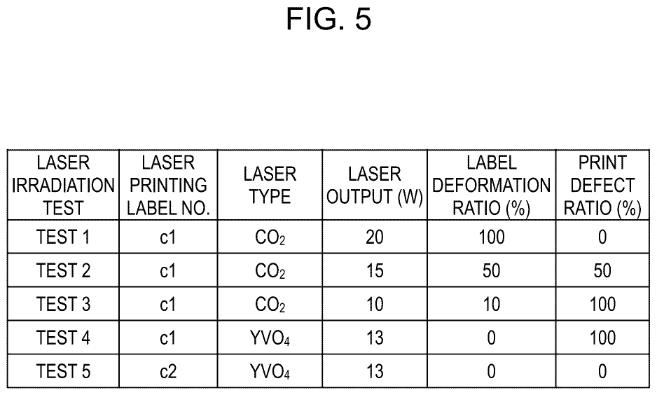

Using the label c1 or c2, laser irradiation was performed under the conditions (laser type and output) shown in FIG. 5, and the reliability of printing by laser irradiation was evaluated.

Specifically, the presence or absence of deformation of the label due to laser irradiation was examined. Ten sheets of each label were prepared, and the ratio (percentage) of the number of deformed sheets to the ten sheets was determined.

In addition, it was examined whether or not predetermined printing was performed in the print region by laser irradiation. When at least a portion of the print portion was not formed (formation of the print portion on the resin base layer by laser irradiation or removal of the Al vapor deposition layer was insufficient), the printing was determined to be defective. Ten sheets of each label were prepared, and the ratio (percentage) of the number of sheets in which printing defects occurred to the ten sheets was determined.

The results of Evaluation 2 are shown in FIG. 5.

In Test 1, the deformation ratio of the label was 100%. In Test 2, the label deformation ratio and the print defect ratio were both 50%. In Test 3, the label deformation ratio was 10%, and the print defect ratio was 100%. In Test 4, the label deformation ratio was 0%, but the print defect ratio was 100%. In Test 5, both the label deformation ratio and the print defect ratio were 0%. From Tests 1 to 5, it was confirmed that sufficient reliability for laser printing could be obtained by appropriately selecting the type and output of the laser for the label including the Al vapor deposition layer.

### Batteries A8 to A13 and B2 to B13

### Preparation of Labels a8 to a13 and Labels b2 to b13

As the labels a8 to a13, label for laser printings constituted by (adhesive layer/Al vapor deposition layer/resin base layer/second ink layer/first ink layer) were produced. The resin base layer was a PET layer.

As the labels b2 to b13, label for laser printings constituted by (adhesive layer/Al vapor deposition layer/resin base layer/second ink layer) were produced. The resin base layer was a PET layer.

A white ink was used to form the first ink layer. Titanium dioxide was used as the white pigment contained in the white ink. Red, yellow, or blue ink was used to form the second ink layer. Pigment Red was used as the red pigment contained in the red ink. Pigment yellow was used as the yellow pigment contained in the yellow ink. Pigment blue was used as the blue pigment contained in the blue ink.

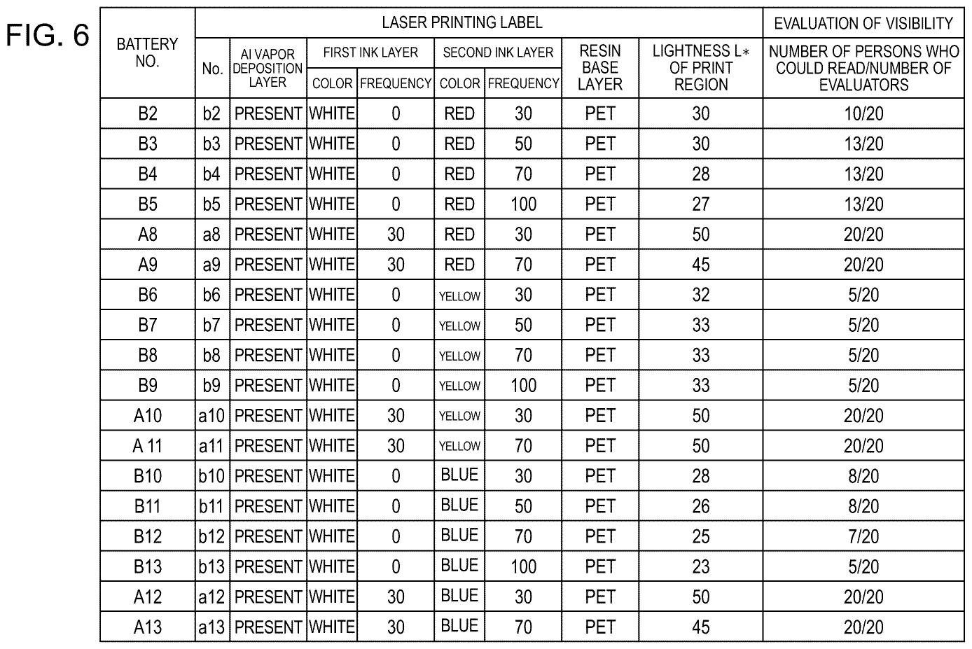

The frequencies of the colors of the first ink layer and the second ink layer were set to values shown in FIG. 6.

The color frequency was calculated from the ratio of the coated area per unit area of the ink (pigment) in the print region, and was adjusted by changing the coated area of the ink (pigment). The frequency of white was expressed as a relative value when the frequency of white in the case of the label a5 was 100. The frequencies of red, yellow, and blue were expressed as relative values when the frequencies of red, yellow, and blue in the cases of labels b5, b9, and b13 were 100, respectively. The number of times the ink was applied for the formation of each ink layer was one.

The labels a8 to a13 and b2 to b13 were produced in the same manner as the label a1 except for the above.

The brightness of the print region of the label was measured by the method described above. The measured brightness was the value shown in FIG. 6.

Batteries A8 to A13 and B2 to B13 to which the labels a8 to a13 and b2 to b13 were attached were produced in the same manner as in the case of the battery A1, except that the labels a8 to a13 and b2 to b13 were used instead of the label a1. Then, Evaluation 1 was performed.

The results of Evaluation 1 are shown in FIG. 6. In FIG. 6, the labels a8 to a13 and the batteries A8 to A13 are practical examples, and the labels b2 to b13 and the batteries B2 to B13 are comparative examples.

In the labels b2 to b13 in which the ink layer was formed only with the red, yellow, or blue ink, the visibility was decreased when the label was attached to the battery (B2 to B13). When red, yellow, or blue ink was used, the lightness L* did not increase even if the color frequency was increased.

When the second ink layer was formed using the red, yellow, or blue ink together with the first ink layer formed using the white ink, a lightness L* of 45 or more was obtained, and the visibility when the label was attached to the battery was good (A8 to A13).

### INDUSTRIAL APPLICABILITY

The label for laser printing according to the present disclosure is suitably used for various batteries such as alkaline dry batteries, manganese dry batteries, and lithium ion secondary batteries.

### REFERENCE SIGNS LIST

1 metal can
1a side portion
1b bottom portion
1c swaged portion
1d groove portion
2 positive electrode
3 negative electrode
4a separator
4b bottom paper
5 gasket
6 negative electrode current collector
7 negative electrode terminal plate
8 outer label
9 power generating element
10 battery
11 metal case
11a side portion
11b first end portion
11c second end portion
20 label for laser printing
20a print region
21 adhesive layer
22 Al vapor deposition layer
23 resin base layer
24 ink layer
25 print portion

1. A label for laser printing for a battery, wherein
the battery comprises a power generating element and a metal case for housing the power generating element,
the label for laser printing includes a print region which is disposed on a surface of the metal case and configured to be printed by laser irradiation, and
the label for laser printing comprises an adhesive layer, an Al vapor deposition layer, a resin base layer, and an ink layer,
the adhesive layer, the Al vapor deposition layer, and the ink layer are disposed in this order from a side of the metal case,
the resin base layer is disposed at an arbitrary position on an opposite side of the adhesive layer to the metal case, and
a lightness L* of at least the print region is 45 or more.

2. The label for laser printing according to claim 1, wherein
the lightness L* is 50 or more and 70 or less.

3. The label for laser printing according to claim 1, wherein
the ink layer contains a white pigment.

4. The label for laser printing according to claim 1, wherein
the resin base layer contains a polyester resin.

5. The label for laser printing according to claim 4, wherein
the polyester resin contains polyethylene terephthalate.

6. A method for manufacturing a battery, the method comprising:
a first step of obtaining the label for laser printing for the battery according to claim 1;
a second step of obtaining the battery comprising a metal case and a power generating element housed in the metal case;
a third step of printing on the print region by laser irradiation;
a fourth step of disposing the label for laser printing on a surface of the metal case;
wherein
in the third step, the printing is performed in the print region by removing a portion of the Al vapor deposition layer by the laser irradiation.

7. The method for manufacturing the battery according to claim 6, wherein
the metal case includes a metal can which has a bottomed cylindrical shape, and
in the fourth step, the label for laser printing is disposed on the surface of the metal can.

8. The method for manufacturing a battery according to claim 6, wherein
a material of the metal case is a nickel-plated steel plate.

9. A battery, comprising:
a power generating element;
a metal case for housing the power generating element; and
a label for laser printing disposed on a surface of the metal case,
wherein
the label for laser printing comprises:
an adhesive layer;
an Al vapor deposition layer;
a resin base layer; and
an ink layer,
the adhesive layer, the Al vapor deposition layer, and the ink layer are disposed in this order from a side of the metal case, and
the resin base layer is disposed at an arbitrary position on an opposite side of the adhesive layer to the metal case,
the label for laser printing includes a print region including a print portion in which a portion of the Al vapor deposition layer has been removed by laser irradiation, and
a lightness L* of a non-print portion other than the print portion in the print region is 45 or more.

10. The battery according to claim 9, wherein
the metal case includes a metal can which has a bottomed cylindrical shape or a bottomed hollow prism shape, and
the label for laser printing is disposed on a surface of the metal can.

11. The battery according to claim 9, wherein
a material of the metal case is a nickel-plated steel plate.
